(19) United States
(12) Patent Application Publication
(10) Pub. No.: US 2026/0127997 A1
(43) Pub. Date: May 7, 2026

(54) DISPLAY DEVICE, DISPLAY DRIVING CHIP, AND DISPLAY DRIVING METHOD

(71) Applicant: Novatek Microelectronics Corp., Hsinchu (TW)

(72) Inventor: Tso-Hua Chien, Hsinchu City (TW)

(73) Assignee: Novatek Microelectronics Corp., Hsinchu (TW)

(21) Appl. No.: 19/382,279

(22) Filed: Nov. 7, 2025

Related U.S. Application Data
(60) Provisional application No. 63/717,793, filed on Nov. 7, 2024.

(51) Int. Cl. G09G 3/20

(52) U.S. Cl. CPC G09G 3/2092; G09G 2310/0245; G09G 2310/0267; G09G 2310/0286; G09G 2330/021

(57) ABSTRACT

The disclosure provides a display device and a display driving chip and a display driving method thereof. The display panel includes a high refresh rate display area and a low refresh rate display area. The display driving chip generates a gate clock signal. The gate clock signal is utilized by the gate driver to generate first scan signals for driving the high refresh rate display area and second scan signals for driving the low refresh rate display area. Both the high refresh rate display area and the low refresh rate display area are refreshed during a full refresh frame period. Only the high refresh rate display area is refreshed during a partial refresh frame period. The gate clock signal has different active periods or different swings in different parts of the full refresh frame period (corresponding to different refresh rate display areas).

### CROSS-REFERENCE TO RELATED APPLICATION

This application claims the priority benefit of U.S. provisional application Ser. No. 63/717,793, filed on Nov. 7, 2024. The entirety of the above-mentioned patent application is hereby incorporated by reference herein and made a part of this specification.

### BACKGROUND

### Technical Field

The disclosure relates to an electronic circuit, and more particularly to a display device and a display driving chip and a display driving method thereof.

### Description of Related Art

On a traditional display panel, the entire display area of the display panel displays one or more images at the same refresh rate. In some applications, such as mobile applications, the entire display area of the display panel may be divided into multiple smaller display areas, but different areas all display the images at the same refresh rate. In many usage scenarios, only a certain display area often needs to be frequently refreshed (such as playing an animation), while another display area shows static image contents and does not need to be frequently refreshed. When the entire display area (all divided display areas) of the traditional display panel operates at a high refresh rate, the power consumption of the display panel is high. At this time, for display areas that do not need to be frequently refreshed, the high refresh rate is a waste of power. When the entire display area of the traditional display panel operates at a low refresh rate, although the power consumption of the display panel is low, the refresh rate is too low for the display area that need to be frequently refreshed.

### SUMMARY

The disclosure provides a display device and a display driving chip and a display driving method thereof, so that different display areas (regions) in the same display panel adaptively have different refresh rates.

In an embodiment of the disclosure, the display driving chip includes a controller. The controller is configured to generate a gate clock signal to control a gate driver of a display panel. A display area of the display panel includes a high refresh rate display area and a low refresh rate display area. Both the high refresh rate display area and the low refresh rate display area are refreshed during a full refresh frame period and only the high refresh rate display area is refreshed during a partial refresh frame period. The gate clock signal is utilized by the gate driver to generate multiple first scan signals and multiple second scan signals. The first scan signals are used to drive multiple scan lines in the high refresh rate display area and the second scan signals are used to drive multiple scan lines in the low refresh rate display area. The gate clock signal has a first active period in a first part of the full refresh frame period (the first part of the full refresh frame period corresponds to the high refresh rate display area) and the gate clock signal has a second active period greater than the first active period in a second part of the full refresh frame period (the second part of the full refresh frame period corresponds to the low refresh rate display area).

In an embodiment of the disclosure, the display driving chip includes a controller. The controller is configured to output a gate clock signal to control a gate driver of a display panel. A display area of the display panel includes a high refresh rate display area and a low refresh rate display area. Both the high refresh rate display area and the low refresh rate display area are refreshed during a full refresh frame period and only the high refresh rate display area is refreshed during a partial refresh frame period. The gate clock signal is utilized by the gate driver to generate multiple first scan signals and multiple second scan signals. The first scan signals are used to drive multiple scan lines in the high refresh rate display area and the second scan signals are used to drive multiple scan lines in the low refresh rate display area. The gate clock signal has a first swing in a first part of the full refresh frame period (the first part of the full refresh frame period corresponds to the high refresh rate display area) and the gate clock signal has a second swing greater than the first swing in a second part of the full refresh frame period (the second part of the full refresh frame period corresponds to the low refresh rate display area).

In an embodiment of the disclosure, the display device includes a display panel and a display driving chip. The display panel includes an active display area and a gate driver. The active display area includes a high refresh rate display area and a low refresh rate display area. The gate driver is used to generate multiple first scan signals for driving multiple scan lines in the high refresh rate display area and multiple second scan signals for driving multiple scan lines in the low refresh rate display area. The display driving chip includes a controller. The controller is configured to generate a gate clock signal to control the gate driver of the display panel. Both the high refresh rate display area and the low refresh rate display area are refreshed during a full refresh frame period and only the high refresh rate display area is refreshed during a partial refresh frame period. The gate clock signal is utilized by the gate driver to generate the first scan signals and the second scan signals. The gate clock signal has a first active period in a first part of the full refresh frame period (the first part of the full refresh frame period corresponds to the high refresh rate display area) and the gate clock signal has a second active period greater than the first active period in a second part of the full refresh frame period (the second part of the full refresh frame period corresponds to the low refresh rate display area).

In an embodiment of the disclosure, the display device includes a display panel and a display driving chip. The display panel includes an active display area and a gate driver. The active display area includes a high refresh rate display area and a low refresh rate display area. The gate driver is used to generate multiple first scan signals for driving multiple scan lines in the high refresh rate display area and multiple second scan signals for driving multiple scan lines in the low refresh rate display area. The display driving chip includes a controller. The controller is configured to output a gate clock signal to control the gate driver of the display panel. Both the high refresh rate display area and the low refresh rate display area are refreshed during a full refresh frame period and only the high refresh rate display area is refreshed during a partial refresh frame period. The gate clock signal is utilized by the gate driver to generate the first scan signals and the second scan signals using. The gate clock signal has a first swing in a first part of the full refresh frame period (the first part of the full refresh frame period corresponds to the high refresh rate display area) and the gate clock signal has a second swing greater than the first swing in a second part of the full refresh frame period (the second part of the full refresh frame period corresponds to the low refresh rate display area).

In an embodiment of the disclosure, the display driving method includes the following steps. A gate clock signal is generated to control a gate driver of a display panel. A display area of the display panel includes a high refresh rate display area and a low refresh rate display area. Both the high refresh rate display area and the low refresh rate display area are refreshed during a full refresh frame period and only the high refresh rate display area is refreshed during a partial refresh frame period. The gate clock signal is utilized by the gate driver to generate multiple first scan signals and multiple second scan signals. The first scan signals are used to drive multiple scan lines in the high refresh rate display area and the second scan signals are used to drive multiple scan lines in the low refresh rate display area. The gate clock signal has different active periods in respective time periods of the full refresh frame period or the gate clock signal has different swings in respective time periods of the full refresh frame period.

Based on the above, the display driving chip according to the embodiments of the disclosure may generate the gate clock signal, and the gate clock signal is utilized by the gate driver to generate the scan signals for driving the high refresh rate display area and the low refresh rate display area. Both the high refresh rate display area and the low refresh rate display area are refreshed during the full refresh frame period and only the high refresh rate display area is refreshed during the partial refresh frame period, so that the frame rate (refresh rate) of the low refresh rate display area of the display panel may be different from that of the high refresh rate display area of the display panel. After a function of providing multiple display areas with different refresh rates is active, if a boundary position between the high refresh rate display area (high refresh area) and the low refresh rate display area (low refresh area) remains unchanged, the display panel will eventually experience an unrecoverable issue of uneven brightness between the high refresh area and low refresh area. An active period of a gate drive signal (the scan signal) of the display panel is determined by the active period of the gate clock signal. The gate clock signal has different active periods or different swing in different parts of the full refresh frame period (corresponding to different refresh rate display areas). Therefore, when the function of providing multiple display areas with different refresh rates is active, an average active period of the gate clock signals in different refresh rate display areas tends to be the same over a long period of time. Over a long period of time, the degree of aging of pixels in the high refresh area and the low refresh area due to stress effect will tend to be consistent, thereby reducing the phenomenon of uneven brightness of the different refresh rate display areas.

In order for the features and advantages of the disclosure to be more comprehensible, the following specific embodiments are described in detail in conjunction with the drawings.

### BRIEF DESCRIPTION OF THE DRAWINGS

FIG. 1 is a schematic diagram of a circuit block of a display device according to an embodiment of the disclosure.

FIG. 2 is a schematic diagram of a circuit block of a gate driver according to an embodiment of the disclosure.

FIG. 3 is a schematic diagram of a signal timing of a gate driver according to an embodiment of the disclosure.

FIG. 4 is a schematic diagram of a flowchart of a display driving method according to an embodiment of the disclosure.

FIG. 5 is a schematic diagram of a waveform of a gate clock signal of a gate driver according to another embodiment of the disclosure.

FIG. 6 is a schematic diagram of a waveform of a scan signal of a gate driver according to an embodiment of the disclosure.

FIG. 7 is a schematic diagram of a waveform of a gate clock signal of a gate driver according to still another embodiment of the disclosure.

FIG. 8 is a schematic diagram of a waveform of a gate clock signal of a gate driver according to yet another embodiment of the disclosure.

FIG. 9 is a schematic diagram of a waveform of a gate clock signal of a gate driver according to again another embodiment of the disclosure.

### DESCRIPTION OF THE EMBODIMENTS

The term “coupling (or connection)” used in the entire specification (including the claims) of the disclosure may refer to any direct or indirect connection means. For example, if a first device is described as being coupled (or connected) to a second device, it should be interpreted that the first device may be directly connected to the second device or the first device may be indirectly connected to the second device through another device or certain connection means. Terms such as “first” and “second” mentioned in the entire specification (including the claims) of the disclosure are used to name the elements or to distinguish between different embodiments or ranges, but not to limit the upper limit or the lower limit of the number of elements nor to limit the sequence of the elements. In addition, wherever possible, elements/components/steps using the same reference numerals in the drawings and the implementation manners represent the same or similar parts. Related descriptions of the elements/components/steps using the same reference numerals or using the same terms in different embodiments may be cross-referenced.

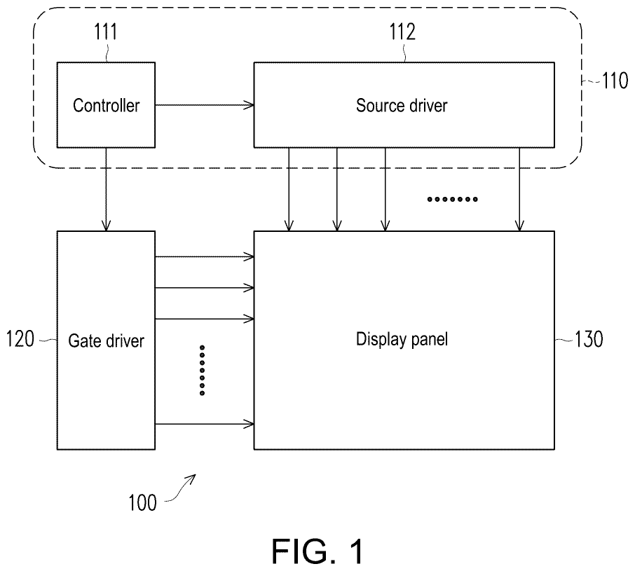

FIG. 1 is a schematic diagram of a circuit block of a display device 100 according to an embodiment of the disclosure. The display device 100 shown in FIG. 1 includes a display driving chip 110, a gate driver 120, and a display panel 130. Based on the actual design, the display panel 130 may include various types of display panels, such as a liquid crystal display (LCD) panel or other display panels. The display driving chip 110 is coupled to multiple data lines (also referred to as source lines) of the display panel 130. The display driving chip 110 may serve as a driver (for example, a source driver) to drive the data lines of the display panel 130.

The display driving chip 110 is coupled to the gate driver 120. The gate driver 120 is coupled to multiple scan lines (also referred to as gate lines) of the display panel 130. Based on the control of the display driving chip 110, the gate driver 120 may scan the scan lines of the display panel 130. According to the actual design, the gate driver 120 may include a gate driver on array (GOA) or other gate driving circuits. In conjunction with a scanning timing of the display panel 130 by the gate driver 120, the display driving chip 110 may drive the data lines of the display panel 130, so that the display panel 130 displays an image.

In some practical application scenarios, the display panel 130 shown in FIG. 1 may not be divided into several display areas. In such an application scenario, the display driving chip 110 shown in FIG. 1 may send a reset pulse (native reset pulse) to the gate driver 120 at the beginning of each frame period (or at the end of each frame period) to clear any scan pulse latched inside the gate driver 120 before scanning the display panel 130. After the native reset pulse occurs, the gate driver 120 may start scanning the scan lines of the display panel 130 based on a vertical start pulse and gate clock signals provided by the display driving chip 110. Therefore, the entire display area of the display panel 130 may be refreshed.

In other practical application scenarios, the entire display area of the display panel 130 shown in FIG. 1 may be divided into two (or more) display areas. For example, an active display area of the display panel 130 includes a high refresh rate display area and a low refresh rate display area. Based on the control of the gate driver 120 by the display driving chip 110, the high refresh rate display area and the low refresh rate display area in the same display panel 130 are adapted to have different refresh rates.

For example (but not limited to), it is assumed that the display panel 130 shown in FIG. 1 includes 1612 scan lines. Based on the actual operating scenario, it is assumed that the display driving chip 110 dynamically defines the 1st to 540th scan lines (540 scan lines of an upper part of the display panel 130) as the high refresh rate display area and the 541st to 1612th scan lines (1072 scan lines of a lower part of the display panel 130) as the low refresh rate display area. Based on the control of the gate driver 120 by the display driving chip 110, the high refresh rate display area of the display panel 130 has a high refresh rate (same as an output frame rate such as 120 Hz that determines how long a frame period is) and the low refresh rate display area of the display panel 130 has a low refresh rate (for example, 60 Hz). Therefore, the display device 100 may reduce the refresh rate of the low refresh rate display area to reduce power consumption, while maintaining the high refresh rate in the high refresh rate display area.

In an application scenario where the display panel 130 is divided into the high refresh rate display area and the low refresh rate display area, the display driving chip 110 shown in FIG. 1 may select a first number (M) of frame periods (referred to as full refresh frame periods during which frames are normally displayed) and select a second number (N) of frame periods (referred to as a partial refresh frame period) in each frame period group (which consists of multiple consecutive frame periods and can be taken as a refresh cycle hereinafter). Both the high refresh rate display area and the low refresh rate display area are refreshed during the full refresh frame period and only the high refresh rate display area is refreshed during the partial refresh frame period. The number of frames in each frame period group may be determined according to the actual design and/or the actual operation. For example (but not limited to), it is assumed that each frame period group includes three consecutive frame periods. The number of full refresh frame periods and the number of partial refresh frame periods in each frame group may be determined according to the actual design and/or the actual operation. In some practical operating scenarios, the display driving chip 110 may select all frame periods of a refresh cycle to be used as full refresh frame periods. In this case, both the high refresh rate display area and the low refresh rate display area of the display panel 130 have the same high refresh rate, which is same as the output frame rate such as 120 Hz. In some practical operating scenarios, the display driving chip 110 may select one frame period of a refresh cycle consisting of three frame periods to be used as the full refresh frame period and select the remaining two frame periods of the refresh cycle to be used as the partial refresh frame periods. In this case, the high refresh rate display area of the display panel 130 displays data by using the high refresh rate (same as the output frame rate) such as 120 Hz, while the low refresh rate display area of the display panel 130 displays data by using the low refresh rate, 40 Hz, as one-third of 120 Hz. In other practical operating scenarios, the display driving chip 110 may select two frame periods of a refresh cycle to be used as the full refresh frame periods and select the remaining frame period of the refresh cycle to be used as the partial refresh frame period. In this case, the high refresh rate display area of the display panel 130 displays data by using the high refresh rate (same as the output frame rate) such as 120 Hz, while the low refresh rate display area of the display panel 130 displays data by using the low refresh rate, 80 Hz, as two-third of 120 Hz.

The display driving chip 110 may send the reset pulse to the gate driver 120 during the full refresh frame period(s) and the partial refresh frame period(s) to clear any scan pulse latched in the gate driver 120. Based on the practical design, in some embodiments, the number of reset pulses during each full refresh frame period is less than the number of reset pulses during each partial refresh frame period. For example, in some embodiments, the number of reset pulses during each full refresh frame period is 1 and the number of reset pulses during each partial refresh frame period is 2. An adjacent position between the high refresh rate display area and the low refresh rate display area of the display panel 130 corresponds to a corresponding time point during each full refresh frame period(s) and each partial refresh frame period(s). The display driving chip 110 sends an additional reset pulse to the gate driver 120 at the corresponding time point during each partial refresh frame period to clear any scan pulse in the gate driver 120.

For example, during each full refresh frame period, the display driving chip 110 sends a single reset pulse (native reset pulse) to the gate driver 120 at the beginning of the frame (or the end of the frame) to clear any scan pulse latched in the gate driver 120. During each partial refresh frame period, the display driving chip 110 sends not only one reset pulse (native reset pulse) at the beginning (or the end) of the frame period but also an additional reset pulse at another time point of the frame period, which is corresponding to the adjacent position between the high refresh rate display area and the low refresh rate display area, to the gate driver 120 to clear the scan pulses latched in the gate driver 120 at different time points during each partial refresh frame period. It is assumed that the upper part of the display panel 130 including 540 scan lines is the high refresh rate display area and the lower part of the display panel 130 including 1072 scan lines is the low refresh rate display area. During each partial refresh frame period, the display driving chip 110 also sends the additional reset pulse to the gate driver 120 when the upper part of the display panel 130 completes scanning. Therefore, the lower part of the display panel 130 as the low refresh rate display area is not scanned during the partial refresh frame period, so that the high refresh rate display area and the low refresh rate display area in the same display panel 130 adaptively have different refresh rates.

In the embodiment shown in FIG. 1, the display driving chip 110 includes a controller 111 and a source driver 112. The source driver 112 is coupled to the data lines of the display panel 130. The controller 111 is coupled to the source driver 112 and the gate driver 120. According to different designs, in some embodiments, the display driving chip 110 and/or the controller 111 may be implemented as hardware circuits. In other embodiments, the display driving chip 110 and/or the controller 111 may be implemented as a combined form of multiple of hardware, firmware, and software (that is, a program).

In terms of the form of hardware, the display driving chip 110 and/or the controller 111 may be implemented as logic circuits on an integrated circuit. For example, related functions of the display driving chip 110 and/or the controller 111 may be implemented in various logic blocks, modules, and circuits in one or more controllers, microcontrollers, microprocessors, application-specific integrated circuits (ASICs), digital signal processors (DSPs), field programmable gate arrays (FPGAs), central processing units (CPUs), and/or other processing units. The related functions of the display driving chip 110 and/or the controller 111 may be implemented as hardware circuits, such as various logic blocks, modules, and circuits in an integrated circuit, using hardware description languages (for example, Verilog HDL or VHDL) or other suitable programming languages.

In terms of the form of software and/or firmware, the related functions of the display driving chip 110 and/or the controller 111 may be implemented as programming codes. For example, the display driving chip 110 and/or the controller 111 may be implemented using common programming languages (for example, C, C++, or assembly languages) or other suitable programming languages. The programming codes may be recorded/stored in a non-transitory machine-readable storage medium. In some embodiments, the non-transitory machine-readable storage medium includes, for example, a semiconductor memory and/or a storage device. An electronic apparatus (for example, a computer, a CPU, a controller, a microcontroller, or a microprocessor) may read and execute the programming codes from the non-transitory machine-readable storage medium, thereby implementing the related functions of the display driving chip 110 and/or the controller 111.

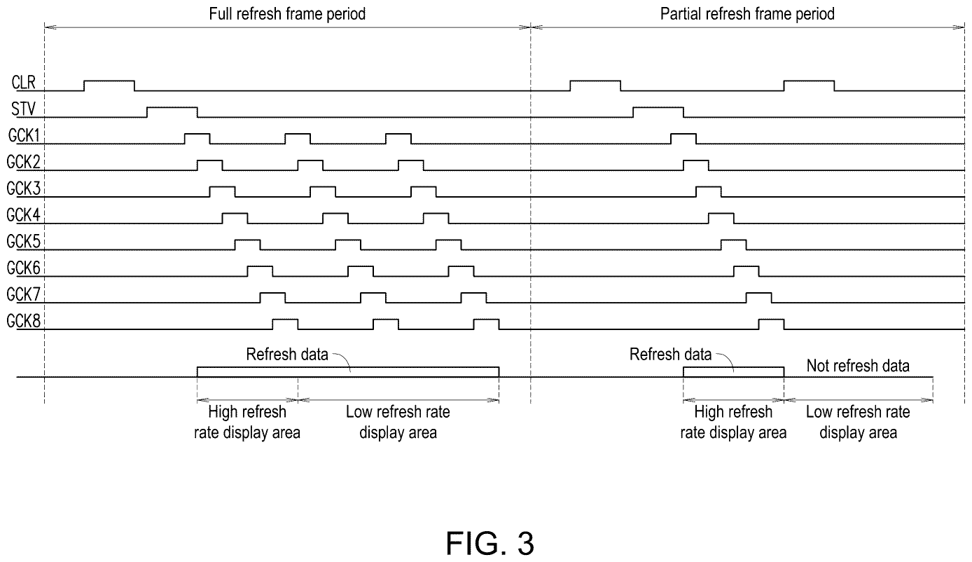

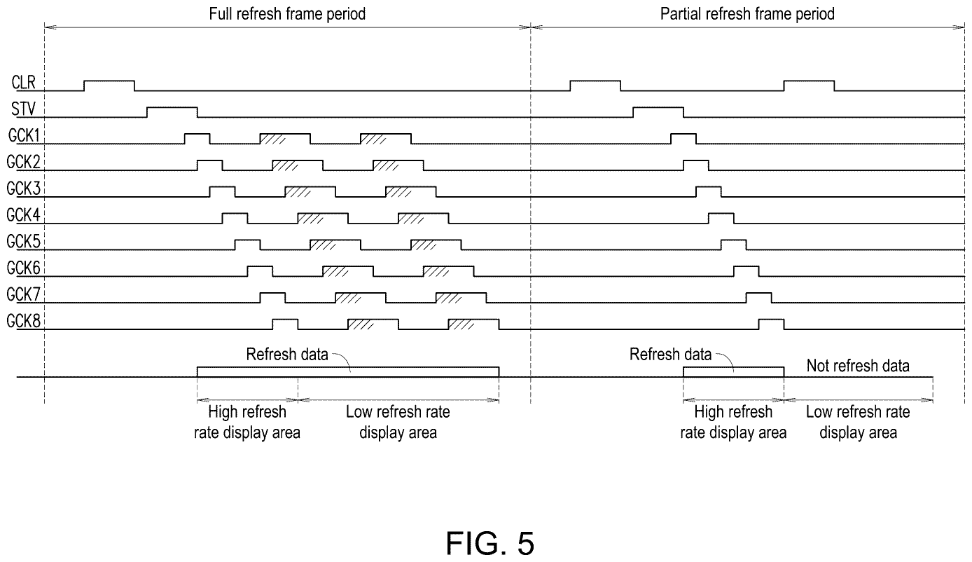

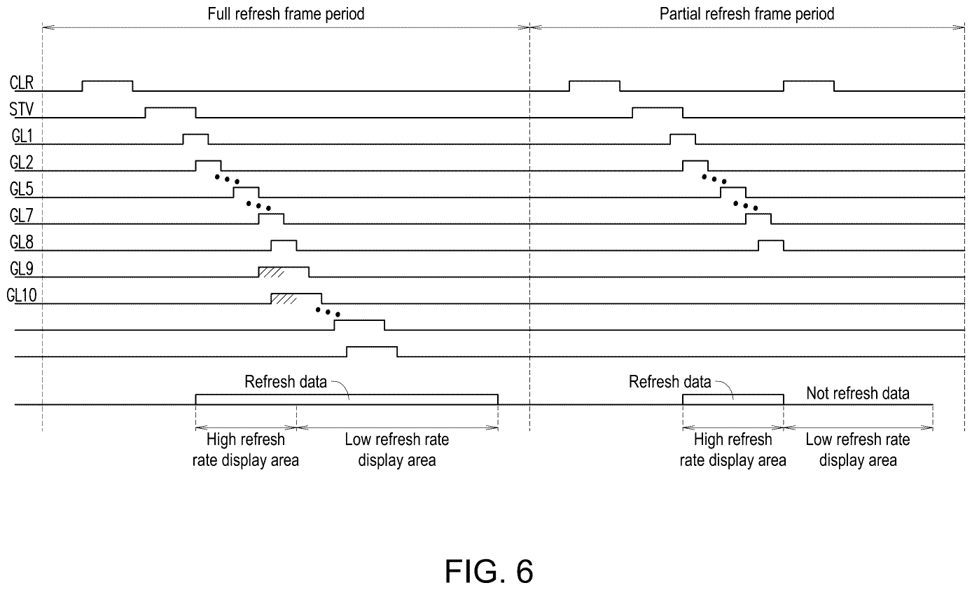

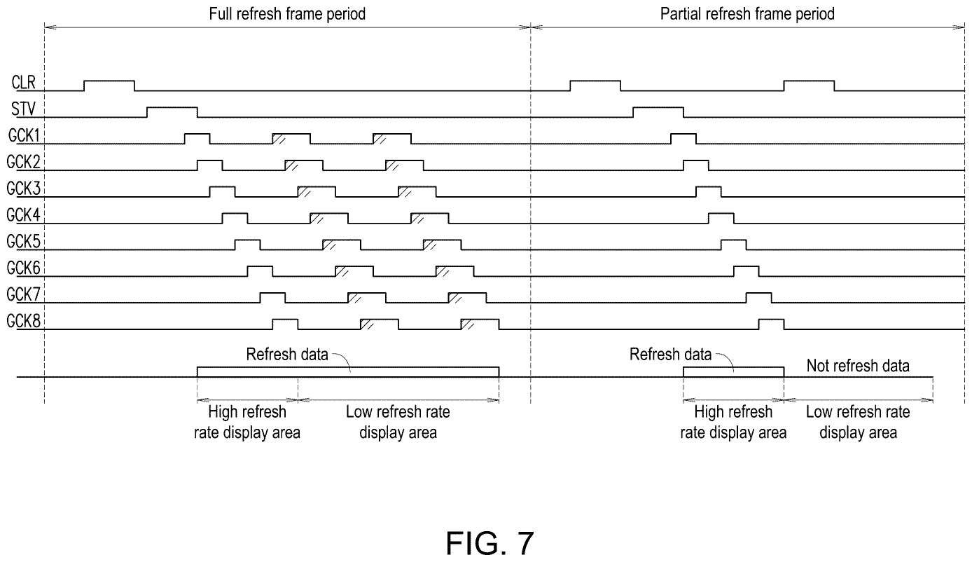

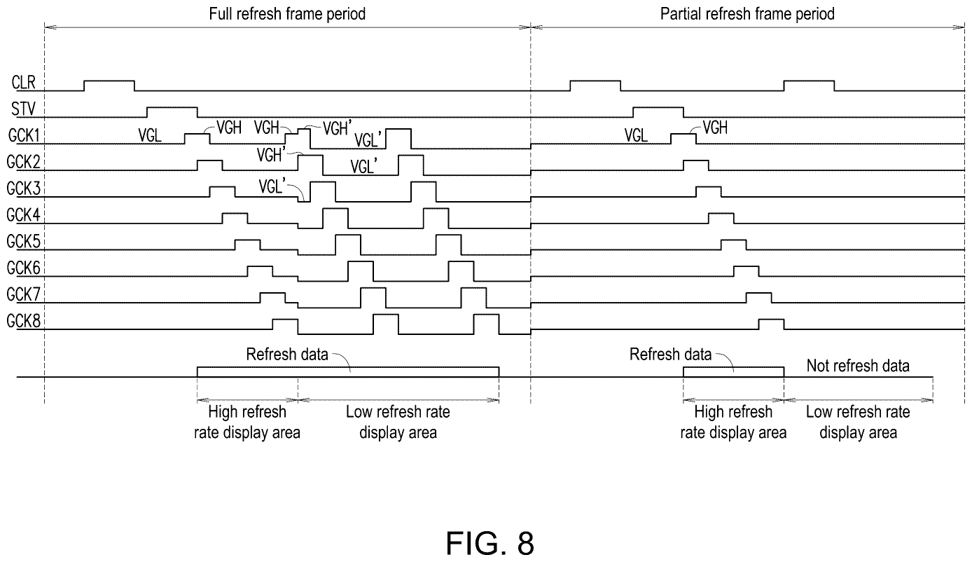

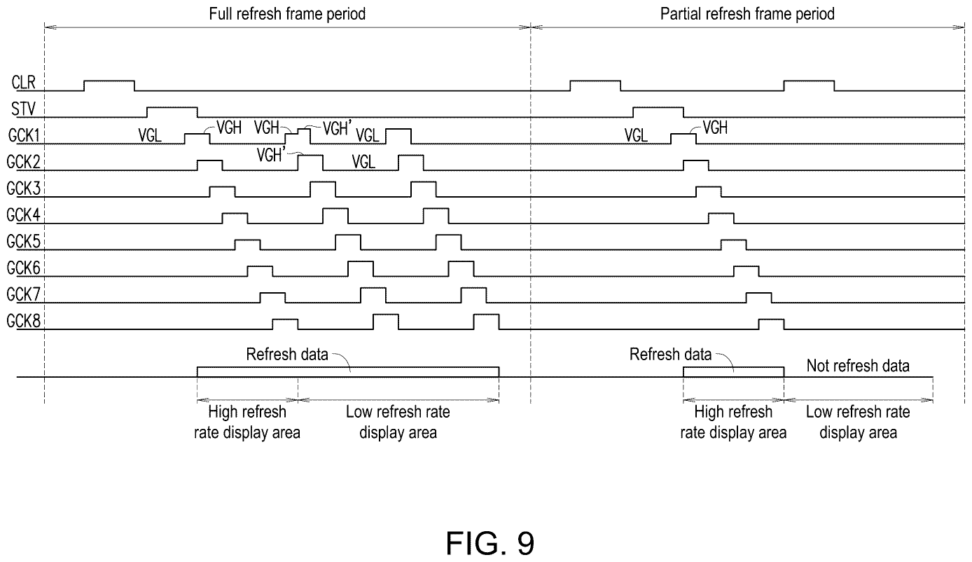

The controller 111 is configured to output the native reset pulse and the additional reset pulse to the gate driver 120 during the partial refresh frame period. During the partial refresh frame period, the reset pulse occurs before multiple gate clock signals start toggling, and the additional reset pulse occurs after the gate clock signals stop toggling (refer to FIG. 3, FIG. 5, FIG. 6, FIG. 7, FIG. 8, or FIG. 9 for details on a reset pulse CLR and gate clock signals GCK1 to GCK8).

The controller 111 is configured to generate the vertical start pulse and the gate clock signal to control the gate driver 120 of the display panel 130. The gate driver 120 is used to drive the scan lines of the display panel 130. For example, the gate clock signal is utilized by the gate driver 120 to generate multiple first scan signals and multiple second scan signals, wherein the first scan signals are used to drive the scan lines in the high refresh rate display area of the display panel 130 and the second scan signals are used to drive the scan lines in the low refresh rate display area of the display panel 130.

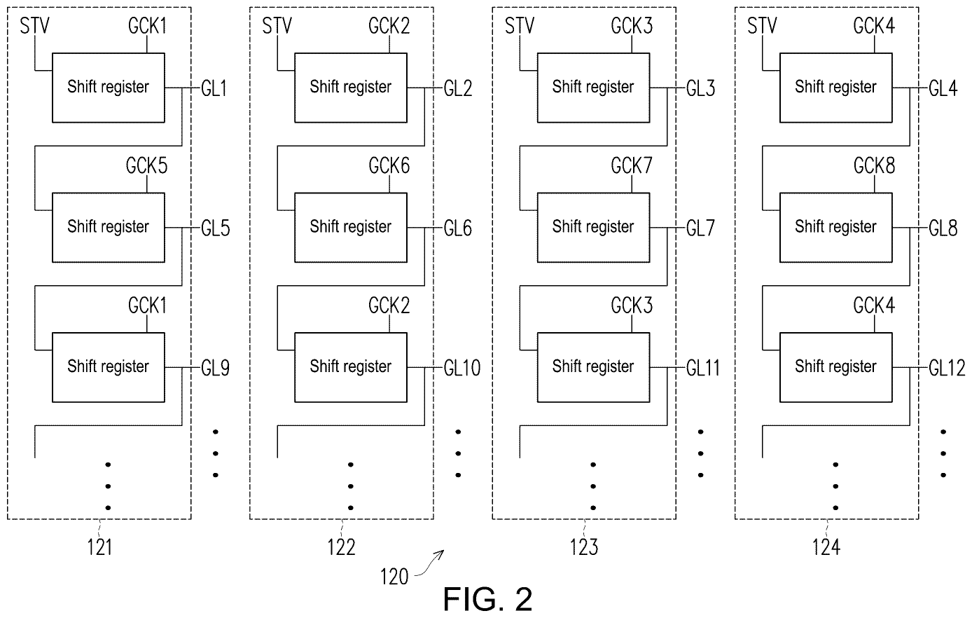

FIG. 2 is a schematic diagram of a circuit block of the gate driver 120 according to an embodiment of the disclosure. The gate driver 120 shown in FIG. 2 may serve as one of many implementation examples of the gate driver 120 shown in FIG. 1. In the embodiment shown in FIG. 2, the gate driver 120 includes multiple shift register groups, such as shift register groups 121, 122, 123, and 124 shown in FIG. 2. Each shift register group 121 to 124 includes multiple shift registers connected in series. An output terminal of each shift register is coupled to a corresponding scan line among the scan lines of the display panel 130 (for example, GL1, GL2, GL3, GL4, GL5, GL6, GL7, GL8, GL9, GL10, GL11, and GL12 shown in FIG. 2) to provide different scan signals (scan pulses of different phases).

An input terminal of a first shift register in each shift register group 121 to 124 receives a vertical start pulse STV, while input terminals of the other shift registers receives the scan pulse output by the previous shift register, as shown in FIG. 2. Each shift register also receives a corresponding gate clock signal among the gate clock signals of different phases (for example, GCK1, GCK2, GCK3, GCK4, GCK5, GCK6, GCK7, and GCK8 shown in FIG. 2). Based on the triggering of the gate clock signals GCK1 to GCK8, each shift register latches the scan pulse at the input terminal thereof, and the output terminals of the shift registers output different scan signals (scan pulses of different phases) to corresponding scan lines among the scan lines (for example, GL1 to GL12 shown in FIG. 2) of the display panel 130. The active period of the scan signal of the scan line, i.e., the pulse width of the scan pulse, of the display panel 130 is determined according to the active period of the gate clock signal GCK1 to GCK8. Furthermore, the level and the swing of the gate clock signals GCK1 to GCK8 may affect the swing of the scan signal output by each shift register.

The function of providing multiple display areas with different refresh rates can be accomplished by setting a refresh cycle composed of M full refresh frame periods and N partial refresh frame periods, where M and N are at least 1. For example, FIG. 3 below shows an example of one refresh cycle composed of one full refresh frame period and one partial refresh frame period.

FIG. 3 is a signal timing diagram of the gate driver 120 according to an embodiment of the disclosure. The horizontal axis of FIG. 3 represents time. The vertical start pulse STV and the shift register may not be limited to one set. The gate clock signals GCK1 to GCK8 shown in FIG. 3 are used to trigger the shift registers of the gate driver 120. The gate clock signals GCK1 to GCK8 shown in FIG. 3 is adapted for a display panel that has an amorphous silicon thin film transistor (a-Si TFT) substrate, wherein the active period of the gate clock signals for this kind of the display panel includes, at least, one horizontal line period corresponding to a data writing period and another one horizontal line period before the horizontal line period corresponding to the data writing period, for turning on the pixel switch (TFT) in advance. Therefore, the active period of the gate clock signals GCK1 to GCK8 shown in FIG. 3 includes at least two horizontal line periods. The exemplary timing diagram of FIG. 3 is illustrated based on an output frame rate 120 Hz, a refresh rate 120 Hz for a high refresh rate display area and a refresh rate 60 Hz for a low refresh rate display area, so that refresh cycle composed of a full refresh frame period and a partial refresh frame period is given in FIG. 5. The frame period shown on the left of FIG. 3 is the full refresh frame period (during which frames are normally displayed). During the full refresh frame period, the reset pulse CLR first clears the scan pulses of all shift registers of the gate driver 120. Then, the controller 111 may provide the vertical start pulse STV and the gate clock signals GCK1 to GCK8 to the gate driver 120, and the active period of the gate clock signals GCK1 to GCK8 in a first part of the full refresh frame period (corresponding to a high refresh rate display area of the display panel 130) and the active period of the gate clock signals GCK1 to GCK8 in a second part of the full refresh frame period (corresponding to a low refresh rate display area of the display panel 130) have the same length of time. Based on the control of the controller 111, the gate driver 120 and the source driver 112 may completely refresh the high refresh rate display area and the low refresh rate display area during the full refresh frame period. Therefore, during the full refresh frame period, the entire display area of the display panel 130 may be normally refreshed.

The frame period shown on the right of FIG. 3 is the partial refresh frame period. During the partial refresh frame period, the gate driver 120 partially scans the high refresh rate display area, but does not scan the low refresh rate display area. The controller 111 sends the native reset pulse CLR to the gate driver 120 at a first time point during the partial refresh frame period, and then in a first part of the partial refresh frame period (corresponding to the high refresh rate display area) the controller consecutively provides the gate clock signals GCK1 to GCK8 to the gate driver 120. The active period of the gate clock signals GCK1 to GCK8 in the first part of the partial refresh frame period (corresponding to the high refresh rate display area of the display panel 130) are the same as the active period of the gate clock signals GCK1 to GCK8 in the first part of the full refresh frame period. In a second part of the partial refresh frame period (corresponding to the low refresh rate display area of the display panel 130), the controller 111 controls the gate clock signals GCK1 to GCK8 to stop toggling. And, the controller 111 also sends the additional reset pulse CLR to the gate driver 120 at a second time point during the partial refresh frame period (a time point corresponding to the adjacent position between the high refresh rate display area and the low refresh rate display area of the display panel 130) to clear the scan pulse of the gate driver 120. Therefore, transmission of the scan pulses of all shift registers of the gate driver 120 stops, so that the low refresh rate display area is not refreshed during the partial refresh frame period. In conjunction with the operating timing of the gate driver 120, the source driver 112 may refresh pixel data of the high refresh rate display area in the first part of the partial refresh frame period and stop refreshing pixel data of the low refresh rate display area in the second part of the partial refresh frame period.

In the second part of the partial refresh frame period (corresponding to the low refresh rate display area of the display panel 130), the source driver 112 may maintain providing a lowest grayscale voltage (or other direct current levels) to the data lines of the display panel 130, maintain a hi-Z impedance state on the data lines, or reduce the frequency of changes in the data lines. Alternatively, a digital data path (digital domain circuit) inside the source driver 112 may enter a power-saving mode.

The controller 111 generates gate the clock signals GCK1 to GCK8, and the gate clock signals GCK1 to GCK8 are utilized by the gate driver 120 to generate the scan signals to drive the high refresh rate display area and the low refresh rate display area of the display panel 130. Both the high refresh rate display area and the low refresh rate display area are refreshed during the full refresh frame period and only the high refresh rate display area is refreshed during the partial refresh frame period, so that the frame rate (refresh rate) of the low refresh rate display area of the display panel 130 may be different from that of the high refresh rate display area of the display panel 130. After a function of providing multiple display areas with different refresh rates is active, if the boundary position between the high refresh rate display area and the low refresh rate display area remains unchanged, pixel switches in the high refresh rate display area may be affected by the stress effect more severely than pixel switches in the low refresh rate display area are affected as the time passes by and the display panel 130 will experience an unrecoverable issue of uneven brightness between the high and low refresh rate display areas over a long period of time.

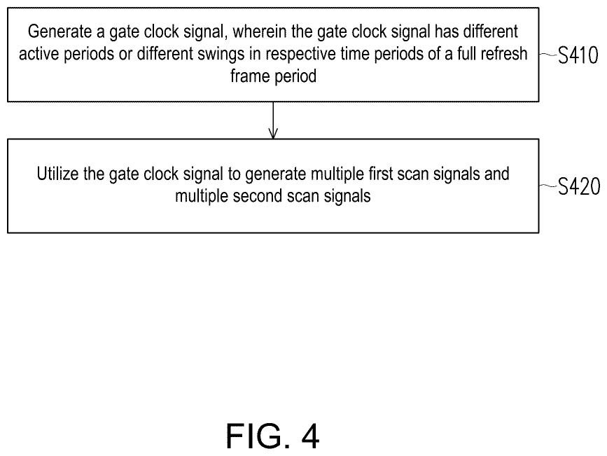

FIG. 4 is a schematic diagram of a flowchart of a display driving method according to an embodiment of the disclosure. Please refer to FIG. 1 and FIG. 4. In step S410, the controller 111 generates the gate clock signal to control the gate driver 120 of the display panel 130. The display panel 130 includes the high refresh rate display area and the low refresh rate display area. Both the high refresh rate display area and the low refresh rate display area are refreshed during the full refresh frame period and only the high refresh rate display area is refreshed during the partial refresh frame period. The gate clock signal has different active periods in respective time periods (corresponding to respective display areas of different refresh rates) of the full refresh frame period or the gate clock signal has different swings in respective time periods of the full refresh frame period. In step S420, the gate clock signal is utilized by the gate driver 120 to generate the first scan signals and the second scan signals, wherein the first scan signals are used to drive the scan lines in the high refresh rate display area and the second scan signals are used to drive the scan lines in the low refresh rate display area.

More specifically, in one refresh cycle composed of M full refresh frame periods and N partial refresh frame periods, an average of active periods of the gate clock signal (such as anyone of GCK1 to GCK8) corresponding to the low refresh rate display area in the M full refresh frame periods is controlled to be close to or equal an average of active periods of the gate clock signal corresponding to the high refresh rate display area in the M full refresh frame periods and active periods of the gate clock signal corresponding to the high refresh rate display area in the N partial refresh frame periods. Or, in one refresh cycle composed of M full refresh frame periods and N partial refresh frame periods, an average of swings of the gate clock signal corresponding to the low refresh rate display area in the M full refresh frame periods is controlled to be larger than an average of swings of the gate clock signal corresponding to the high refresh rate display area in the M full refresh frame periods. As a result, pixel switches in the low refresh rate display area may be affected by the stress effect in a degree that is similar to pixel switches in the high refresh rate display area are affected, and uneven brightness between the high refresh rate display area and low refresh rate display area may be eliminated. The following implementation examples illustrate an adjustment operation of the active period of the gate clock signals GCK1 to GCK8 in the second part of the full refresh frame period.

FIG. 5 is a schematic diagram of waveforms of the gate clock signals GCK1 to GCK8 of the gate driver 120 according to another embodiment of the disclosure. The horizontal axis of FIG. 5 represents time. The reset pulse CLR, the vertical start pulse STV, the gate clock signals GCK1 to GCK8, the full refresh frame period, and the partial refresh frame period shown in FIG. 5 may be deduced from the related descriptions of FIG. 3. The gate clock signals GCK1 to GCK8 shown in FIG. 5 is adapted for a display panel that has an amorphous silicon thin film transistor (a-Si TFT) substrate, and the exemplary timing diagram of FIG. 5 illustrates a refresh cycle composed of a full refresh frame period and a partial refresh frame period, based on an output frame rate 120 Hz, a refresh rate 120 Hz for a high refresh rate display area and a refresh rate 60 Hz for a low refresh rate display area. When the function of providing multiple display areas with different refresh rates is active, the controller 111 increases the active period of the gate clock signals GCK1 to GCK8 in the low refresh rate display area during the full refresh frame period. The gate clock signals GCK1 to GCK8 have the first active period in the first part of the full refresh frame period (corresponding to the high refresh rate display area of the display panel 130), the first active period consisting of two horizontal line periods, which are one horizontal line period for turning on the pixel switch before data writing and one later horizontal line period corresponding to data writing, and the gate clock signals GCK1 to GCK8 have the second active period greater than the first active period in the second part of the full refresh frame period (corresponding to the low refresh rate display area of the display panel 130), the second active period consisting of four horizontal line periods which are three horizontal line periods for turning on the pixel switch before data writing and the latest horizontal line period corresponding to data writing. In other words, the active period (second active period) of the gate clock signals GCK1 to GCK8 in the second part of the full refresh frame period has two extra horizontal line periods for turning on the pixel switch in advance than the active period (first active period) of the gate clock signals GCK1 to GCK8 in the first part of the full refresh frame period. The active period, remarked as a third active period, of the gate clock signals GCK1 to GCK8 in a first part of the partial refresh frame period has the same time length as the active period (first active period) of the gate clock signals GCK1 to GCK8 in the first part of the full refresh frame period, and the gate clock signals GCK1 to GCK8 stops toggling in a second part of the partial refresh frame period (corresponding to the low refresh rate display area).

According to the setting of the active periods of the gate clock signals as above, in the refresh cycle shown in FIG. 5, an average active period of the gate clock signals GCK1 to GCK8 corresponding to the low refresh rate display area is two horizontal line periods, which equals a result of the second active period (i.e., four horizontal line periods) divided by a sum (i.e., two frame periods) of the number of full refresh frame periods and the number of partial refresh frame periods in the refresh cycle. An average active period of the gate clock signals GCK1 to GCK8 corresponding to the high refresh rate display area in the refresh cycle is two horizontal line periods. Therefore, over a long period of time, the aging of pixels in the high refresh rate display area and the low refresh rate display area due to stress effect will become similar, thereby reducing the phenomenon of uneven brightness.

FIG. 6 is a schematic diagram of a waveform of the scan signal of the gate driver 120 according to an embodiment of the disclosure. The horizontal axis of FIG. 6 represents time. The reset pulse CLR, the vertical start pulse STV, the full refresh frame period, and the partial refresh frame period shown in FIG. 6 may be deduced from the related descriptions of FIG. 5. The gate clock signals GCK1 to GCK8 shown in FIG. 5 are utilized by the gate driver 120 to generate the scan signals to the scan lines (for example, GL1 to GL12 shown in FIG. 2 and FIG. 6) of the display panel 130.

During the full refresh frame period, the active period of the scan signals of the high refresh rate display area (for example, the scan lines GL1 to GL8) is two horizontal line periods and the active period of the scan signals of the low refresh rate display area (for example, the scan lines GL9, GL10, . . . ) is four horizontal line periods. Therefore, considering one refresh cycle consisting of two frame periods (i.e., one full refresh frame period and one partial refresh frame period), the average active period of the scan signals in the low refresh rate display area is the same as (similar to) the average active period of the scan signals in the high refresh rate display area. When the average active periods of the gate clock signals GCK1 to GCK8 in the high refresh rate display area and low refresh rate display area are the same or similar, the difference in the degree of aging of pixels in different display areas due to stress effect may be effectively reduced, thereby reducing the phenomenon of uneven brightness.

FIG. 7 is a schematic diagram of waveforms of the gate clock signals GCK1 to GCK8 of the gate driver 120 according to still another embodiment of the disclosure. The horizontal axis of FIG. 7 represents time. The reset pulse CLR, the vertical start pulse STV, the gate clock signals GCK1 to GCK8, the full refresh frame period, and the partial refresh frame period shown in FIG. 7 may be deduced from the related descriptions of FIG. 3. The gate clock signals GCK1 to GCK8 shown in FIG. 7 is adapted for a display panel that has an amorphous silicon thin film transistor (a-Si TFT) substrate, and the exemplary timing diagram of FIG. 7 illustrates a refresh cycle composed of a full refresh frame period and a partial refresh frame period, based on an output frame rate 120 Hz, a refresh rate 120 Hz for a high refresh rate display area and a refresh rate 60 Hz for a low refresh rate display area. When the function of providing multiple display areas with different refresh rates is active, the controller 111 adds the active period of the gate clock signals GCK1 to GCK8 in the second part of the full refresh frame period (corresponding to the low refresh rate display area), such that the gate clock signals GCK1 to GCK8 have the second active period greater than the first active period in the second part of the full refresh frame period. Therefore, during the refresh cycle, the average active period of the gate clock signals GCK1 to GCK8 in the low refresh rate display area may be similar to the average active period of the gate clock signals GCK1 to GCK8 in the high refresh rate display area.

During the full refresh frame period shown in FIG. 7, the active period of the gate clock signals GCK1 to GCK8 in the first part of the full refresh frame period (corresponding to the high refresh rate display area) is 2 horizontal line periods, wherein the earlier horizontal line period is used for turning on the pixel switch in advance and the later horizontal line period is corresponding to a data writing period. During the full refresh frame period shown in FIG. 7, compared to the active period of the gate clock signals GCK1 to GCK8 in the first part of the full refresh frame period, one more horizontal line period is added to the active period of the gate clock signals GCK1 to GCK8 in the second part of the full refresh frame period (corresponding to the low refresh rate display area) and it is added to the period for turning on the pixel switch in advance (indicated by a diagonal line), that is, the active period of the gate clock signals GCK1 to GCK8 in the second part of the full refresh frame period is 3 horizontal line periods. Considering the one refresh cycle shown in FIG. 7, the average active period of the gate clock signals GCK1 to GCK8 corresponding to the low refresh rate display area is 1.5 horizontal line periods, which is close to the average active period (i.e., 2 horizontal line periods) of the gate clock signals GCK1 to GCK8 corresponding to the high refresh rate display area. Although the average active periods corresponding to different display areas of different refresh rates are not exactly the same, enlarging the active period of the gate clock signals in the second part of the full refresh frame period leads to a better effect than not changing it (as in FIG. 3). When the average active period of the gate clock signals GCK1 to GCK8 in the high refresh rate display area and the low refresh rate display area are similar, the difference in the degree of aging of panel pixels may be effectively reduced, thereby reducing the phenomenon of uneven brightness.

The number of the full refresh frame periods and the number of the partial refresh frame periods in one refresh cycle can be determined based on an output frame rate (which may equal the highest refresh rate) and the desired refresh rate of the low refresh rate display area. In embodiments of the present disclosure, how many horizontal line periods that the active period of the gate clocks in the second part of the full refresh frame period is expected to be increased, to become larger than the active period of the gate clocks in the first part of the full refresh frame period, is determined by the number of the full refresh frame periods and the number of the partial refresh frame periods in one refresh cycle, and a target average active period corresponding to the lower refresh rate display areas. Besides, embodiments of the present disclosure are not limited by the type of TFT substrates that a display panel uses, and not only a display panel with a-Si TFT substrate but also a display panel with low-temperature polycrystalline silicon (LTPS) TFT substrate is adapted for applying the embodiments. The gate clock signals used in the display panel with LTPS TFT substrate do not need to turn on pixel switch in advance by one horizontal line period earlier than data writing. In the case of the display panel with LTPS TFT substrate, based on a refresh cycle defined by a refresh rate 120 Hz for the high refresh rate display area and a refresh rate 60 Hz for the low refresh rate display area, the gate clocks in the first part of the full refresh frame period may have a first active period that is one horizonal line period and the gate clocks in the second part of the full refresh frame period may have a second active period that is two horizonal line periods consisting of a later horizontal line period corresponding to the data writing period and an earlier horizontal line period for increasing time for turning on the pixel switch. As a result, in one refresh cycle, the average active period of the gate clock signals corresponding to the low refresh rate display area is one horizontal line periods, which equals a result of the second active period (i.e., two horizontal line periods in the case of LTPS display panel) divided by a sum (i.e., two frame periods) of the number of full refresh frame periods and the number of partial refresh frame periods in the refresh cycle. The average active period of the gate clock signals corresponding to the low refresh rate display area in one refresh cycle is also the same as the average active period of the gate clock signals corresponding to the high refresh rate display area in the refresh cycle.

FIG. 8 is a schematic diagram of waveforms of the gate clock signals GCK1 to GCK8 of the gate driver 120 according to yet another embodiment of the disclosure. The horizontal axis of FIG. 8 represents time. The reset pulse CLR, the vertical start pulse STV, the gate clock signals GCK1 to GCK8, the full refresh frame period, and the partial refresh frame period shown in FIG. 8 may be deduced from the related descriptions of FIG. 3. When the function of providing multiple display areas with different refresh rates is active, the controller 111 increases the swing of the gate clock signals GCK1 to GCK8 in the second part of the full refresh frame period (corresponding to the low refresh rate display area). The gate clock signals GCK1 to GCK8 have a first swing in the first part of the full refresh frame period (corresponding to the high refresh rate display area of the display panel 130) and the gate clock signals GCK1 to GCK8 have a second swing greater than the first swing in the second part of the full refresh frame period. The gate clock signals GCK1 to GCK8 have the first swing in the first part of the partial refresh frame period (corresponding to the high refresh rate display area of the display panel 130) and the gate clock signals GCK1 to GCK8 are maintained at a certain ineffective voltage level (for example, a low logic level VGL) in the second part of the partial refresh frame period (corresponding to the low refresh rate display area of the display panel 130). In the embodiment shown in FIG. 8, the first swing is from the low logic level VGL to a high logic level VGH (the gate clock signals GCK1 to GCK8 switch between the low logic level VGL and the high logic level VGH), and the second swing is from a low logic level VGL′ to a high logic level VGH′ (the gate clock signals GCK1 to GCK8 switch between the low logic level VGL′ and the high logic level VGH′), wherein VGH′>VGH and VGL′<VGL. The actual levels of VGH, VGL, VGH′, and VGL′ may be determined according to the actual design and application. Therefore, during the full refresh frame period and the partial refresh frame period, the average swing of the gate clock signals GCK1 to GCK8 corresponding to the low refresh rate display area may be similar to the average swing of the gate clock signals GCK1 to GCK8 corresponding to the high refresh rate display area.

The high level and the low level of the scan signals are determined by the high logic level and the low logic level of the gate clock signals GCK1 to GCK8 input to the shift registers of the gate driver 120. When the function of providing multiple display areas with different refresh rates is active, the controller 111 increases the swing of the gate clock signals GCK1 to GCK8 in the second part of the full refresh frame period (corresponding to the low refresh rate display area), which helps to reduce the difference in the degree of aging of TFTs in the high refresh area and the low refresh area due to stress effect over a long period of time.

The swing of the gate clock signals GCK1 to GCK8 may be increased by raising the high logic level of the gate clock signals GCK1 to GCK8, lowering the low logic level of the gate clock signals GCK1 to GCK8, or adjusting both the high and low logic levels. In the embodiment, although the average active periods of the gate clock signals GCK1 to GCK8 corresponding to the high refresh rate display area and the low refresh rate display area are not consistent, increasing the swing of the gate clock signals GCK1 to GCK8 corresponding to the low refresh rate display area helps to appropriately accelerate the aging of pixels. On average, the aging of pixels in high refresh rate display area and the aging of pixels in the low refresh rate display area may tend to be consistent. Therefore, increasing the swing of the gate clock signals GCK1 to GCK8 in the second part of the full refresh frame period (corresponding to the low refresh rate display area) may reduce the difference in the degree of the aging of pixels between the high refresh rate display area and the low refresh rate display area, thereby reducing the phenomenon of uneven brightness.

FIG. 9 is a schematic diagram of waveforms of the gate clock signals GCK1 to GCK8 of the gate driver 120 according to again another embodiment of the disclosure. The horizontal axis of FIG. 9 represents time. The reset pulse CLR, the vertical start pulse STV, the gate clock signals GCK1 to GCK8, the full refresh frame period, and the partial refresh frame period shown in FIG. 9 may be deduced from the related descriptions of FIG. 3. When the function of providing multiple display areas with different refresh rates is active, the controller 111 increases the swing of the gate clock signals GCK1 to GCK8 in the second part of the full refresh frame period (corresponding to the low refresh rate display area). The gate clock signals GCK1 to GCK8 have the first swing in the first part of the full refresh frame period (corresponding to the high refresh rate display area of the display panel 130) and the gate clock signals GCK1 to GCK8 have the second swing greater than the first swing in the second part of the full refresh frame period. In the embodiment shown in FIG. 9, the first swing is from the low logic level VGL to the high logic level VGH and the second swing is from the low logic level VGL to the high logic level VGH′, wherein VGH′>VGH.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. A display driving chip, comprising:
a controller, configured to generate a gate clock signal to control a gate driver of a display panel, wherein a display area of the display panel comprises a high refresh rate display area and a low refresh rate display area, wherein both the high refresh rate display area and the low refresh rate display area are refreshed during a full refresh frame period and only the high refresh rate display area is refreshed during a partial refresh frame period, wherein the gate clock signal is utilized by the gate driver to generate a plurality of first scan signals to drive a plurality of scan lines of the high refresh rate display area and a plurality of second scan signals to drive a plurality of scan lines of the low refresh rate display area, and
the gate clock signal has a first active period in a first part of the full refresh frame period, the first part of the full refresh frame period corresponds to the high refresh rate display area, the gate clock signal has a second active period greater than the first active period in a second part of the full refresh frame period, and the second part of the full refresh frame period corresponds to the low refresh rate display area.

2. The display driving chip according to claim 1, wherein the gate clock signal has a third active period same as the first active period in a first part of the partial refresh frame period, the first part of the partial refresh frame period corresponds to the high refresh rate display area, the gate clock signal stops switching in a second part of the partial refresh frame period, and the second part of the partial refresh frame period corresponds to the low refresh rate display area.

3. The display driving chip according to claim 2, wherein:
the controller is configured to output a reset pulse and an additional reset pulse to the gate driver during the partial refresh frame period; and
during the partial refresh frame period, the reset pulse occurs before a plurality of gate clock signals start toggling and the additional reset pulse occurs after the plurality of gate clock signals stop toggling.

4. The display driving chip according to claim 2, wherein in one refresh frame period composed of M full refresh frame periods and N partial refresh periods, where M and N are at least one, an average value of the active periods of the gate clock signal corresponding to the low refresh rate display area in the M full refresh frame periods and the active periods of the gate clock signal corresponding to the low refresh rate display area in the N partial refresh frame periods is close to or equals to an average value of the active periods of the gate clock signal corresponding to the high refresh rate display area in the M full refresh frame periods and the active periods of the gate clock signal corresponding to the high refresh rate display area in the N partial refresh frame periods.

5. A display driving chip, comprising:
a controller, configured to output a gate clock signal to control a gate driver of a display panel, wherein a display area of the display panel comprises a high refresh rate display area and a low refresh rate display area, wherein both the high refresh rate display area and the low refresh rate display area are refreshed during a full refresh frame period and only the high refresh rate display area is refreshed during a partial refresh frame period, wherein
the gate clock signal is utilized by the gate driver to generate a plurality of first scan signals to drive a plurality of scan lines of the high refresh rate display area and a plurality of second scan signals to drive a plurality of scan lines of the low refresh rate display area, and
the gate clock signal has a first swing in a first part of the full refresh frame period, the first part of the full refresh frame period corresponds to the high refresh rate display area, the gate clock signal has a second swing greater than the first swing in a second part of the full refresh frame period, and the second part of the full refresh frame period corresponds to the low refresh rate display area.

6. The display driving chip according to claim 5, wherein the gate clock signal has a third swing same as the first swing in a first part of the partial refresh frame period, the first part of the partial refresh frame period corresponds to the high refresh rate display area, the gate clock stays at an inactive voltage level in a second part of the partial refresh frame period, and the second part of the partial refresh frame period corresponds to the low refresh rate display area.

7. The display driving chip according to claim 5, wherein the gate clock signal switches between a low logic level and a high logic level, and
during the full refresh frame period, the low logic level of the gate clock signal corresponding to the low refresh rate display area is lower than the low logic level of the gate clock signal corresponding the high refresh rate display area.

8. The display driving chip according to claim 5, wherein the gate clock signal switches between a low logic level and a high logic level, and
during the full refresh frame period, the high logic level of the gate clock signal corresponding to the low refresh rate display area is higher than the high logic level of the gate clock signal corresponding to the high refresh rate display area.

9. A display device, comprising:
a display panel, comprising:
an active display area, comprising a high refresh rate display area and a low refresh rate display area; and
a gate driver, used to generate a plurality of first scan signals for driving a plurality of scan lines of the high refresh rate display area and a plurality of second scan signals for driving a plurality of scan lines of the low refresh rate display area; and
a display driving chip, comprising:
a controller, configured to generate a gate clock signal to control the gate driver of the display panel, wherein both the high refresh rate display area and the low refresh rate display area are refreshed during a full refresh frame period and only the high refresh rate display area is refreshed during a partial refresh frame period, wherein
the gate clock signal is utilized by the gate driver to generate the plurality of first scan signals and the plurality of second scan signals, and
the gate clock signal has a first active period in a first part of the full refresh frame period, the first part of the full refresh frame period corresponds to the high refresh rate display area, the gate clock signal has a second active period greater than the first active period in a second part of the full refresh frame period, and the second part of the full refresh frame period corresponds to the low refresh rate display area.

10. The display device according to claim 9, wherein the gate clock signal has a third active period same as the first active period in a first part of the partial refresh frame period, the first part of the partial refresh frame period corresponds to the high refresh rate display area, the gate clock signal stops switching in a second part of the partial refresh frame period, and the second part of the partial refresh frame period corresponds to the low refresh rate display area.

11. The display device according to claim 10, wherein the controller is configured to output a reset pulse and an additional reset pulse to the gate driver during the partial refresh frame period and during the partial refresh frame period, the reset pulse occurs before a plurality of gate clock signals start toggling and the additional reset pulse occurs after the plurality of gate clock signals stop toggling.

12. The display device according to claim 10, wherein in one refresh frame period composed of M full refresh frame periods and N partial refresh periods, where M and N are at least one, an average value of the active periods of the gate clock signal corresponding to the low refresh rate display area in the M full refresh frame periods and the active periods of the gate clock signal corresponding to the low refresh rate display area in the N partial refresh frame periods is close to or equals to an average value of the active periods of the gate clock signal corresponding to the high refresh rate display area in the M full refresh frame periods and the active periods of the gate clock signal corresponding to the high refresh rate display area in the N partial refresh frame periods.

13. A display device, comprising:
a display panel, comprising:
an active display area, comprising a high refresh rate display area and a low refresh rate display area; and
a gate driver, used to generate a plurality of first scan signals for driving a plurality of scan lines of the high refresh rate display area and a plurality of second scan signals for driving a plurality of scan lines of the low refresh rate display area; and
a display driving chip, comprising:
a controller, configured to output a gate clock signal to control the gate driver of the display panel, wherein both the high refresh rate display area and the low refresh rate display area are refreshed during a full refresh frame period and only the high refresh rate display area is refreshed during a partial refresh frame period, wherein
the gate clock signal is utilized by the gate driver to generate the plurality of first scan signals and the plurality of second scan signals, and
the gate clock signal has a first swing in a first part of the full refresh frame period, the first part of the full refresh frame period corresponds to the high refresh rate display area, the gate clock signal has a second swing greater than the first swing in a second part of the full refresh frame period, and the second part of the full refresh frame period corresponds to the low refresh rate display area.

14. The display device according to claim 13, wherein the gate clock signal has a third swing same as the first swing in a first part of the partial refresh frame period, the first part of the partial refresh frame period corresponds to the high refresh rate display area, the gate clock stays at an inactive voltage level in a second part of the partial refresh frame period, and the second part of the partial refresh frame period corresponds to the low refresh rate display area.

15. The display device according to claim 13, wherein the gate clock signal switches between a low logic level and a high logic level and during the full refresh frame period, the low logic level of the gate clock signal corresponding to the low refresh rate display area is lower than the low logic level of the gate clock signal corresponding the high refresh rate display area.

16. The display device according to claim 13, wherein the gate clock signal switches between a low logic level and a high logic level and during the full refresh frame period, the high logic level of the gate clock signal corresponding to the low refresh rate display area is higher than the high logic level of the gate clock signal corresponding to the high refresh rate display area.

17. A display driving method, comprising:
generating a gate clock signal to control a gate driver of a display panel, wherein a display area of the display panel comprises a high refresh rate display area and a low refresh rate display area, wherein both the high refresh rate display area and the low refresh rate display area are refreshed during a full refresh frame period and only the high refresh rate display area is refreshed during a partial refresh frame period, wherein
the gate clock signal is utilized by the gate driver to generate a plurality of first scan signals for driving a plurality of scan lines of the high refresh rate display area and a plurality of second scan signals for driving a plurality of scan lines of the low refresh rate display area, and
the gate clock signal has different active periods in respective time periods of the full refresh frame period or the gate clock signal has different swings in respective time periods of the full refresh frame period.

18. The display driving method according to claim 17, wherein the gate clock signal has a first active period in a first part of the full refresh frame period, the first part of the full refresh frame period corresponds to the high refresh rate display area, the gate clock signal has a second active period greater than the first active period in a second part of the full refresh frame period, and the second part of the full refresh frame period corresponds to the low refresh rate display area.

19. The display driving method according to claim 17, wherein the gate clock signal has a first swing in a first part of the full refresh frame period, the first part of the full refresh frame period corresponds to the high refresh rate display area, the gate clock signal has a second swing greater than the first swing in a second part of the full refresh frame period, and the second part of the full refresh frame period corresponds to the low refresh rate display area.
